(19) United States
(12) Patent Application Publication
(10) Pub. No.: US 2012/0100993 A1
(43) Pub. Date: Apr. 26, 2012

(54) Plant Growth Enhancement with Combinations of PESA and Herbicides

(76) Inventors: Franklin Paul Silverman, Highland Park, IL (US); Peter D. Petracek, Grayslake, IL (US); Gregory D. Venburg, Deerfield, IL (US)

(21) Appl. No.: 13/276,786

(22) Filed: Oct. 19, 2011

Related U.S. Application Data
(60) Provisional application No. 61/394,866, filed on Oct. 20, 2010.

(51) Int. Cl. A01N 37/44; A01P 13/00

(52) U.S. Cl. 504/322

(57) ABSTRACT

N-(phenylethyl)succinamic acid or its salts is applied as a seed treatment or applied directly on or near the root zone of the seedling or growing herbicide resistant or tolerant plants to protect growth in the presence of selected herbicides.

### FIELD OF THE INVENTION

The present invention is directed to improving plant growth using N-(phenylethyl)succinamic acid (PESA) or its salts to protect plants from an herbicide. This is accomplished using a treatment of N-(phenylethyl)succinamic acid or its salts when an herbicide is used, where PESA is applied as a seed treatment or applied directly to or near the root zone of a seedling or growing plant which is herbicide resistant or tolerant to protect growth in the presence of selected herbicides.

### BACKGROUND OF THE INVENTION

N-(2-phenylethyl)succinamic acid (PESA) is taught as an active ingredient of a plant growth regulator in WO 99/45774, which describes that amido acids including N-(phenylethyl)succinamic acid (PESA) are root growth promoters.

A variety of herbicides are used to kill unwanted plants (weeds) in crop fields, lawns, greenhouses or orchards. Typically, these herbicides are sprayed and subsequently incorporated into the soil (pre-emergence) or onto the plants (post-emergence).

Herbicides can be expensive, and their use may result in unintended consequences such as groundwater contamination, crop damage, environmental damage, spray drift, and human and mammalian health concerns. In particular, protection of young seedlings and plants from pre-emergence herbicides would reduce or avoid unintended herbicidal effects such as delayed early growth and stunting.

There are many classes of herbicides that may be grouped based on their mode of action: see Mallory-Smith and Retzinger, 2003. Weed Technology. 17:605-619). One class of herbicides of particular interest is inhibitors of 5-enolpyruvylshikimate-3-phosphate synthase (EPSP synthase), glyphosate (N-(phosphonomethyl) glycine), which inhibit the production of aromatic amino acids necessary for the synthesis of proteins. Another class of herbicides of interest is inhibitors of glutamine synthesis, glufosinate (2-amino-4-(hydroxymethylphosphinyl) butanoic acid or its esters or salts), which inhibit the production of glutamine, an essential amino acid in protein synthesis. Another class of herbicides of interest is synthetic auxins. A particular example is dicamba (3,6-dichloro-2-methoxybenzoic acid or its salts). Another class of herbicides of interest is inhibitors of acetolactate synthase, the imidazolinones. Examples of this family include the herbicides imazamethabenz, imazamox, imazapic, imazapyr, imazaquin, and imazethapyr.

It is an object of the present invention to protect or safen crops, turf or ornamental plants which are resistant to specific herbicides, either through a transgene which confers resistance, or through a non-transgenic trait that confers resistance to the herbicide, from unintended herbicidal consequences of herbicide application. It is also an object of this invention to lessen the effects of spray drift on non-target species when these herbicides are used.

### SUMMARY OF THE INVENTION

The present invention is directed to a method for improving plant growth of herbicide resistant plants using N-(phenylethyl)succinamic acid or its salts, when an herbicide is used. This is accomplished by using N-(phenylethyl)succinamic acid or its salts as a seed treatment or by application directly on or near the root zone of a seedling or growing plant. Alternatively, PESA may be applied to the shoots or leaves of the plant. Because the herbicide treatments may differentially affect the root and shoot of the plant, less than optimal growth results in an imbalance of the root to shoot ratio. This invention may permit the use of PESA with herbicides to maintain optimal plant growth.

### DETAILED DESCRIPTION OF THE INVENTION

Herbicides are compounds used to kill unwanted plants (weeds) in crop fields, lawns, greenhouses or orchards. Typically, herbicides are sprayed and subsequently incorporated into the soil (pre-emergence) or onto the plants (post-emergence). Herbicides are generally specific in their mode-of-action.

Suitable herbicides include but are not limited to (N-(phosphonomethyl) glycine) or its salts (glyphosate), 2-amino-4-(hydroxymethylphosphinyl)butanoic acid or its esters or salts (glufosinate), or 3,6-dichloro-2-methoxybenzoic acid or its salts (dicamba), or 2-[4,5-dihydro-4-methyl-4-(1-methylethyl)-5-oxo-1H-imidazol-2-yl]-3-pyridinecarboxylic acid or its esters or salts (imazapyr).

PESA is N-(2-phenylethyl)succinamic acid of the formula:

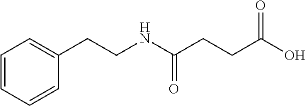

In the present invention, any pesticidally acceptable salt of PESA can also be used as well as PESA. Examples of such salts include calcium, magnesium, potassium, sodium, or ammonium. The organic ammonium salts include the salts formed by neutralization of PESA by an amine bearing one, two or three groups selected from the group consisting of C1-C4 alkyl groups and C1-C4 hydroxyalkyl groups. Typical examples of organic ammonium salts include the trimethylammonium salt, isopropylammonium salt, 2-hydroxyethylammonium salt (ethanolamine salt), 2-hydroxyethyldimethylammonium salt (dimethylethanolamine salt), bis(2-hydroxyethyl)ammonium salt (diethanolamine salt) and tris(2-hydroxyethyl)ammonium salt (triethanolamine salt). The presently preferred salt is the sodium salt.

The salts of PESA are produced, for example, by dissolving the free acid (PESA) in water and adding an equimolar amount of a base to the solution. In the case of the sodium salt, sodium hydroxide is preferably used as the base and this method allows for the production of sodium salt solution ranging in concentration from 0.1 to 40%.

The compositions useful in the method of this invention comprise PESA or its salts. The amount of PESA or its salts in the composition is an amount effective for enhancing the activity of the herbicide while maintaining root and shoot growth, and is usually between 0.5 and 99 times by weight of the amount of the herbicide used. The amount of PESA or its salts is usually 0.02 to 20% by weight of the composition.

The composition further comprises a carrier, and optionally comprises auxiliaries for incorporation into the formulation. Examples of such auxiliaries include surfactants, dispersing agents, thickeners, stabilizing agents, antifreezing agents and colorants.

Examples of solid carriers include powders and granules of clays such as kaoline clay, diatomaceous earth, bentonite, fubasami clay and terra alba; synthetic hydrated silica; talc; ceramic; other inorganic minerals such as sericite, quartz, sulfur, activated carbon, calcium carbonate and hydrated silica; and chemical fertilizers such as ammonium sulfate, ammonium phosphate, ammonium nitrate, ammonium chloride and urea. Examples of liquid carries include aromatic and aliphatic hydrocarbons such as xylene, toluene, alkylnaphthalene, phenylxylylethane, kerosene, gas oil, hexane and cyclohexane; halogenated hydrocarbons such as chlorobenzene, dichloromethane, dichloroethane and trichloroethane; alcohols such as methanol, ethanol, isopropyl alcohol, butanol, hexanol, benzyl alcohol and ethylene glycol; ethers such as diethyl ether, ethylene glycol dimethyl ether, diethylene glycol monomethyl ether, diethylene glycol monoethyl ether, propylene glycol monomethyl ether, tetrahydrofuran and dioxane; esters such as ethyl acetate and butyl acetate; ketones such as acetone, methyl ethyl ketone, methyl isobutyl ketone and cyclohexanone; nitriles such as acetonitrlile and isobutyronitrile; sulfoxides such as dimethyl sulfoxide (DMSO); amides such as N,N-dimethylformamide, N,N-dimethylacetamide and N-methylpyrollidone; alkylydene carbonates such as propylene carbonate; vegetable oils such as soybean oil and cotton seed oil; plant essential oils such as orange oil, hyssop oil and lemon oil; and water. Examples of gaseous carriers include butane gas, ion gas, liquefied petroleum gas (LPG), dimethyl ether and carbon dioxide. When the composition contains a carrier, the amount of the carrier is usually 1 to 99% by weight of the composition.

Examples of surfactants include alkylsulfate salts, alkylsulfonate salts, alkylarylsulfonate salts such as alkylbenzenesulfonate salts and alkylnaphthalenesulfonate salts, polyoxyethylene alkyl ether phosphate salts, alkylaryl ethers, polyoxyethylene alkylaryl ethers, polyethylene glycol ethers, polyvalent alcohol esters and sugar alcohols. Examples of dispersing agents include calcium ligninsulfonate, methylcellulose and hydroxymethylcellulose.

Examples of thickeners include aluminum magnesium silicate, gum arabic, polyvinyl alcohol and polyvinylpyrrolidone.

Examples of stabilizing agents include BHT (2,6-di-tert-butyl-4-methylphenol) and BHA (mixture of 2-tert-butyl-4-methoxyphenol and 3-tert-butyl-4-methoxyphenol).

Examples of antifreezing agents include ethylene glycol, propylene glycol, trimethylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like, diethylene glycol, triethylene glycol, tetraethylene glycol, polyoxyethylene or polyoxypropylene glycols of molecular weight up to about 4000, diethylene glycol monomethyl ether, diethylene glycol monoethyl ether, triethylene glycol monomethyl ether, butoxyethanol, butylene glycol monobutyl ether, dipentaerythritol, tripentaerythritol, tetrapentaerythritol, diglycerol, triglycerol, tetraglycerol, pentaglycerol, hexaglycerol, heptaglycerol and octaglycerol.

Examples of colorants include azo dyestuffs and anthraquinone dyestuffs. When the composition contains a colorant, the amount of the colorant is usually 0.01 to 1.0% by weight of the composition.

The composition useful in the method of the present invention is prepared by conventional methods, for example, by mixing PESA or its salt, a carrier and optionally auxiliaries, and further pulverization, granulation and so on. The composition of the present invention can be a variety of formulations: dry flowables (DF), liquid flowables (LF), true liquids (TL), emulsifiable concentrates (EC), dusts (D), wettable powders (WP), suspoemulsions (SE), water-dispersible granules (WG) and others. Some are registered for use only by commercial applicators using closed application systems, others are readily available for on-farm use as dusts, slurries, water soluble bags, or liquid ready-to-apply formulations.

The method of the present invention is a new use of PESA or its salts for protecting a plant with a trait or transgene that confers resistance to a herbicide from the herbicide by a treatment with PESA or its salts. It is performed by applying PESA or its salts to plants. The plant can be any part and in any stage, for example, seed, tuber, bulb, root, leaf, stem and sprout. PESA or its salts may also be applied to surroundings of the plant, for example, soil. The soil treatment can be performed by application on the soil surface, application by mixing with soil, or the like. PESA or its salts is used in an effective amount for protecting the plant from the herbicidal compound. The amount of PESA or its salts used in the invention depends on the plant species.

The method can be performed by applying the PESA treatment followed by the herbicide of the present invention to plants or surroundings of the plants

Especially suitable target plants are alfalfa, canola, maize, cotton, soybean, sugarbeet, turf, wheat, or other crops or ornamental plants

Suitable target crops are transgenic crop plants of the foregoing varieties. The transgenic crop plants treated according to the invention are plants, or propagation materials thereof, which are transformed by recombinant DNA technology so that they are capable of expressing a herbicidal resistance gene. These plants may be resistant to an herbicide through either a transgene or conventional trait. Examples of transgenes would be those resistance to glyphosate, conferred by a gene encoding an EPSP synthase (5-enolpyruvylshikimate-3-phosphate synthase) that is not inhibited by glyphosate; with plants expressing a bacterial gene encoding the PAT protein (phosphinothricin acetyl transferase), that provides tolerance to, glufosinate; or plants expressing a bacterial dicamba monooxygenase (DMO) gene that confers resistance to the herbicide dicamba. A conventional trait may also provide this protection, such as in Clearfield rice, which is tolerant of imidazolinone herbicides through expression of an altered acetolactate synthase.

The compositions are particularly suited for applications on plant propagation material. The latter term embraces seeds of all kinds (fruit, tubers, grains), cuttings, cut shoots and the like. The preferred field of application is the treatment of all kinds of seeds (as specified in the target crops above), and in particular, the seed treatment of canola, maize, cereals, soybeans and other legumes and turfgrass.

A presently preferred application method of use of the composition of the present invention is seed treatment. Further, a presently preferred application method of PESA or its salts in the method of the present invention is also seed treatment. In seed treatment, the application amount of the composition of the present invention is usually 1 to 200 g, preferably 5 to 100 g per 100 kg of seeds.

### Procedure for Treating Samples of Seed in the Laboratory

Seed is sieved with a screen of mesh size appropriate to remove broken seeds and small trash. Cracked or otherwise damaged seeds were removed. The seed are well mixed, and 50 g samples were weighed into small plastic trays. Seed treatment slurries are made by adding measured amounts of PESA or its salts and other A is to sufficient water to bring them up to a standard volume, typically 2 ml. A fungicide (Maxim XL; Syngenta Agricultural Products, Greensboro, N.C.), a polymeric binder (CF-Clear; Becker-Underwood, Ames, Iowa), and a colorant (Color Coat Red; Becker-Underwood, Ames, Iowa) are also included in the slurry at label rates. A small aliquot of this slurry is applied to the seed using the Hege 11 coater (Wintersteiger, Salt Lake City, Utah) with a six-inch bowl at a slurry rate of 30 ounces per 100 lbs of seed. The slurry is deposited drop-wise on the spinning disk atomizer using a syringe.

After treatment, each seed sample is placed in plastic trays and dried at a room temperature for 20 to 60 minutes. The samples are then placed in small plastic bags. Samples are spot-checked using a water activity meter to make sure the water activity is below 0.7.

The following examples are intended to illustrate the present invention and to teach one of ordinary skill in the art how to make and use the invention. They are not intended to be limiting in any way.

### EXAMPLES

### Example 1

Seeds of Roundup Ready® (glyphosate-resistant) maize may be treated with a formulation containing phenethylsuccinamic acid (PESA). These seeds may be planted in soil and after emergence, the maize plants may be sprayed with glyphosate herbicide.

### Example 2

Seeds of Liberty Link® (glufosinate-resistant) maize may be treated with a formulation containing phenethylsuccinamic acid (PESA). These seeds may be planted in soil and after emergence, the maize plants may be sprayed with glufosinate herbicide.

### Example 3

Seeds of dicamba-resistant soybeans may be treated with a formulation containing phenethylsuccinamic acid (PESA). These seeds may be planted in soil and after emergence, the soybean plants may be sprayed with dicamba herbicide.

### Example 4

Seeds of imidazolinone-resistant rice may be treated with a formulation containing phenethylsuccinamic acid (PESA). These seeds may be planted in soil and after emergence, the rice plants may be sprayed with an imidazolinone herbicide, such as imazapyr.

### Example 5

Further examples of herbicides, traits and crops for which PESA seed treatment or foliar spray treatment may confer benefit are listed in table 1.

TABLE 1
List of Crop Plants, Herbicide Resistance Traits, and Herbicides
for which PESA treatment may confer a benefit.

| Crop | Trait | Herbicide |
|---|---|---|
| Alfalfa | EPSP synthase | glyphosate |
| Brassica sp., including | EPSP synthase | glyphosate |
| canola | | |
| Cotton | EPSP synthase | glyphosate |
| Maize | EPSP synthase | glyphosate |
| Sorghum | EPSP synthase | glyphosate |
| Soybean | EPSP synthase | glyphosate |
| Sugarbeet | EPSP synthase | glyphosate |
| Turf | EPSP synthase | glyphosate |
| Wheat | EPSP synthase | glyphosate |
| Brassica sp., including | phosphinothricin acetyl | glufosinate |
| canola | transferase (PAT) | |
| Cotton | (phosphinothricin acetyl | glufosinate |
| | transferase), | |
| Maize | (phosphinothricin acetyl | glufosinate |
| | transferase), | |
| Soybean | (phosphinothricin acetyl | glufosinate |
| | transferase), | |
| Cotton | dicamba | dicamba |
| | monooxygenase | |
| Maize | dicamba | dicamba |
| | monooxygenase | |
| Soybean | dicamba | dicamba |
| | monooxygenase | |
| Brassica sp., including | altered acetolactate | Imidazolinone type |
| canola | synthase | |
| Maize | altered acetolactate | Imidazolinone type |
| | synthase | |
| Rice | altered acetolactate | Imidazolinone type |
| | synthase | |
| Sunflower | altered acetolactate | Imidazolinone type |
| | synthase | |
| Wheat | altered acetolactate | Imidazolinone type |
| | synthase | |

1. A method for improving plant growth of herbicide resistant plants comprising applying to said plants an effective amount of PESA or its salts and an effective amount of at least one herbicide.

2. The method of claim 1 wherein the plants are seeds.

3. The method of claim 1 wherein the application to plants is foliar.
